(19) United States
(12) Patent Application Publication
(10) Pub. No.: US 2010/0094816 A1
(43) Pub. Date: Apr. 15, 2010

(54) Safety-Critical Data Checking In Object-Oriented Systems

(75) Inventors: Robert B. Groves, JR., Manassas, VA (US); Michael Lamana, Warrenton, VA (US); Richard A. Allshouse, Manassas, VA (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/207,246

(22) Filed: Sep. 9, 2008

(51) Int. Cl. G06F 17/30

(52) U.S. Cl. 707/697; 707/E17.005

(57) ABSTRACT

Methods for detecting the corruption of vital data during the execution of object-oriented programs are disclosed. In accordance with the illustrative embodiments, code is generated at run-time for computing a checksum of vital data in an object, and the code is inserted into the object. When the object is created, this code is executed to compute an initial checksum, and subsequently the code re-computes the checksum during program execution so that a change in the checksum—and inferentially, a change in one or more vital data—can be detected. The checksum is subsequently re-computed during program execution—either periodically, or in response to events such as when the object is modified or when a method of the object is invoked.

### FIELD OF THE INVENTION

The present invention relates to computer software in general, and, more particularly, to safety-critical object-oriented systems.

### BACKGROUND OF THE INVENTION

Typically in a safety-critical system there are one or more data whose values should not be corrupted or changed in an unwanted fashion. In some domains such as the rail industry, such safety-critical data are sometimes referred to as vital data.

It is therefore imperative that a safety-critical system be capable of detecting when corruption or changes to vital data occur. One technique for detecting such occurrences is to compute a checksum of vital data when the data are initialized, and subsequently (e.g., at pre-defined time intervals, upon retrieval of a datum, etc.) re-compute the checksum and check whether its value has changed. If there is a change in the value of the checksum, then it is likely, albeit not certain, that one or more values of the vital data have changed; similarly, when there is no change in the value of the checksum, then it is it is likely, albeit not certain, that none of the vital data have changed.

### SUMMARY OF THE INVENTION

In the prior art, checksums have been used for detecting data corruption during the execution of programs written in the C programming language. However, it is not straightforward to employ this approach in object-oriented programming languages such as C++, Java, etc. due to: the dynamic nature of objects during run-time, the fact that objects can be nested inside of other objects, and the relegation of memory layout to the programming environment.

The present invention provides a mechanism in which corruption of vital data can in fact be detected during the execution of object-oriented programs. In accordance with the illustrative embodiments, code is generated at run-time for computing a checksum of vital data in an object, and the code is inserted into the object. When the object is created, this code is executed to compute an initial checksum, and subsequently the code re-computes the checksum during program execution so that a change in the checksum—and inferentially, a change in one or more vital data—can be detected.

In the first illustrative embodiment of the present invention, the checksum is re-computed periodically during program execution. In the second illustrative embodiment of the present invention, the checksum is re-computed when the object is first accessed, whenever the object is modified, and whenever a method of the object is invoked. The third illustrative embodiment is similar to the second illustrative embodiment, except that instead of code being generated and inserted into an object, a code template within the object is instantiated.

In the fourth illustrative embodiment of the present invention, the checksum of a collection object (e.g., a set, a list, a hashtable, etc.) is re-computed when the object is first accessed, whenever a method of the object is invoked, and whenever an object is added to or deleted from the collection object. The fifth illustrative embodiment is similar to the fourth illustrative embodiment, except that instead of code being generated and inserted into a collection object, a code template within the collection object is instantiated. In the sixth illustrative embodiment of the present invention, the add( ) method of the collection object is overridden to update checksums accordingly.

The illustrative embodiment comprises: generating, at run-time, a software object that comprises one or more safety-critical data; generating, at run-time, code for detecting a change in a value of the safety-critical data; and inserting, at run-time, the code into the software object.

### BRIEF DESCRIPTION OF THE DRAWINGS

FIG. 1 depicts a schematic diagram of the memory footprint of an illustrative object comprising vital data, in accordance with the first and second illustrative embodiments of the present invention.

FIG. 2 depicts a method of generating and deploying code at run-time for detecting the corruption of vital object data, in accordance with the first illustrative embodiment of the present invention.

FIG. 3 depicts a method of generating and deploying code at run-time for detecting the corruption of vital object data, in accordance with the second illustrative embodiment of the present invention.

FIG. 4 depicts a method of instantiating a code template at run-time for detecting the corruption of vital object data, in accordance with the third illustrative embodiment of the present invention.

FIG. 5 depicts a schematic diagram of the memory footprint of an illustrative collection object comprising vital data, in accordance with the fourth illustrative embodiment of the present invention.

FIG. 6 depicts a method of generating and deploying code at run-time for detecting the corruption of vital data in a collection object, in accordance with the fourth illustrative embodiment of the present invention.

FIG. 7 depicts a detailed flowchart for task 670, as shown in FIG. 6, in accordance with the fourth illustrative embodiment of the present invention.

FIG. 8 depicts a method of instantiating a code template at run-time for detecting the corruption of vital data in a collection object, in accordance with the fifth illustrative embodiment of the present invention.

FIG. 9 depicts a method of initializing a collection object, in accordance with the sixth illustrative embodiment of the present invention.

FIG. 10 depicts the salient tasks performed when an object is added to a collection object, in accordance with the sixth illustrative embodiment of the present invention.

### DETAILED DESCRIPTION

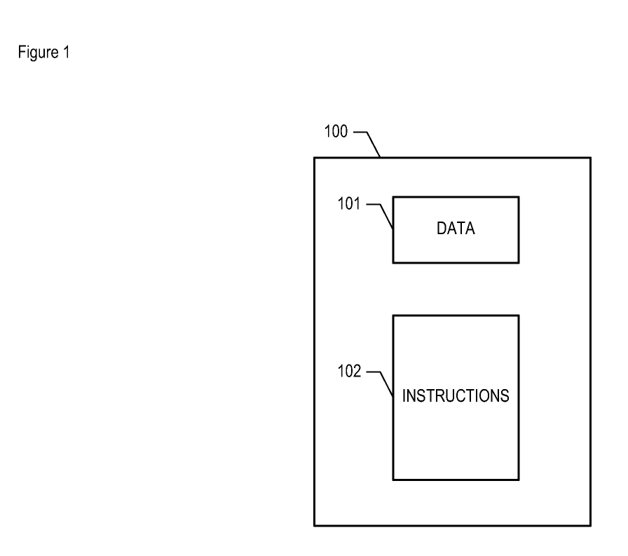

FIG. 1 depicts a schematic diagram of memory footprint 100 of an illustrative object comprising vital data, in accordance with the first and second illustrative embodiments of the present invention. As shown in FIG. 1, memory footprint 100 comprises first memory segment 101 and second memory segment 102.

First memory segment 101 stores one or more object data, as is well known in the art. In accordance with the first illustrative embodiment, at least one, and possibly all, of the data are vital.

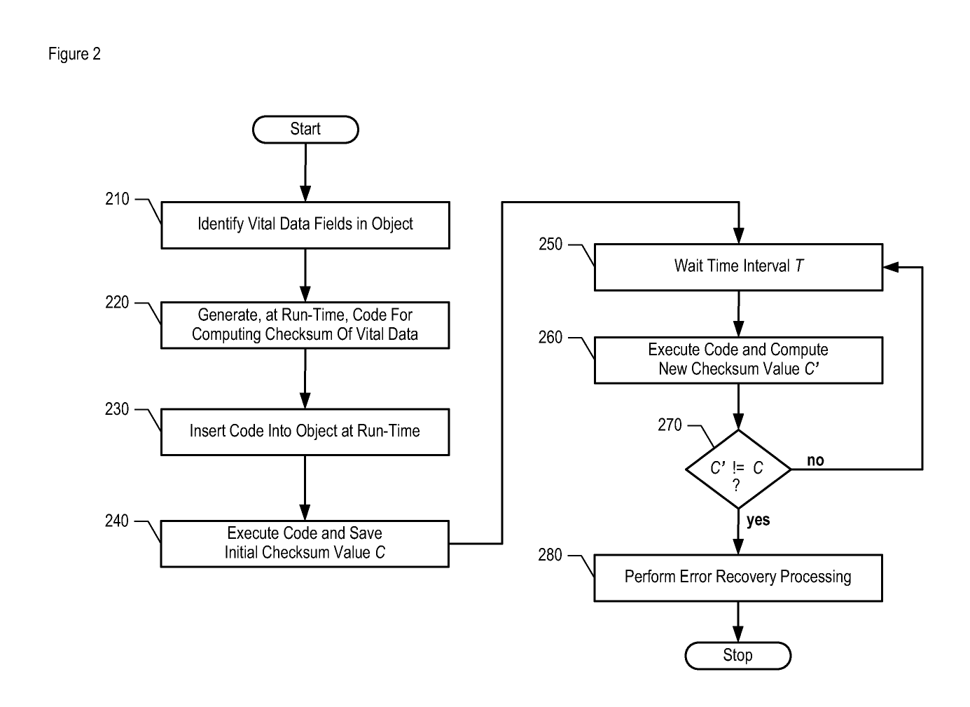

Second memory segment 102 comprises instructions corresponding to the methods of the object, as is well-known in the art. In addition, a portion of memory segment 102 is reserved upon creation for subsequent insertion of instructions for computing a checksum and detecting changes in vital data, as is described in detail below and with respect to FIG. 2.

FIG. 2 depicts a method of generating and deploying code at run-time for detecting the corruption of vital object data, in accordance with the first illustrative embodiment of the present invention. It will be clear to those skilled in the art, after reading this disclosure, which tasks depicted in FIG. 2 can be performed simultaneously or in a different order than that depicted.

At task 210, the vital data fields of an object are identified. As will be appreciated by those skilled in the art, in some embodiments of the present invention vital data fields might be “marked” by a pre-defined data type or keyword, while in some other embodiments, an external data source (e.g., a plaintext file, a Unified Modeling Language document, etc.) might indicate which fields of the object are vital data.

At task 220, code for computing a checksum of vital data is generated at run-time. As will be appreciated by those skilled in the art, in some embodiments of the present invention, the generated code might be produced by employing the generic code features of a programming language tailored by the datum needing protection. Alternatively, in some other embodiments of the present invention, just-in-time compilation (a technique whereby source code is not compiled until needed) might be employed in conjunction with source code tailoring from the executing program to produce a loadable module for computing the checksum of the vital datum.

In still other embodiments of the present invention, retrieval generation code might be employed to form executable data fetch instructions with source addresses of vital data which are linked to the main program via jump tables. This type of mechanism is particularly applicable to programming languages that are not as feature-rich as typical third- and fourth-generation object-oriented languages.

In accordance with the illustrative embodiments of the present invention, a cyclic redundancy check (CRC) is employed as the checksum. As will be appreciated by those skilled in the art, in some other embodiments of the present invention an alternative type of checksum might be employed, and it will be clear to those skilled in the art, after reading this disclosure, how to make and use such embodiments.

At task 230, the code generated at task 220 is inserted into the object at run-time. In accordance with the illustrative embodiment, the code is linked into the main program either by (i) the program environment, in the case of generic applications, or (ii) altering low level jump vectors, in the case of less capable programming languages.

At task 240, the code generated at task 220 is executed, and the checksum value computed by the code is stored in variable C.

At task 250, the method waits for a time interval T, where the particular value of T corresponds to how often the checksum of the vital object data is re-computed.

At task 260, the code generated at task 220 is executed, and the checksum value computed by the code is stored in variable C′.

Task 270 checks whether the values of C and C′ differ; if so, execution of the method continues at task 280, otherwise execution continues back at task 250.

At task 280, appropriate error processing is performed in response to the corruption of the vital data (e.g., lock down the system, issue an alert, etc.). After task 280, the method of FIG. 2 terminates.

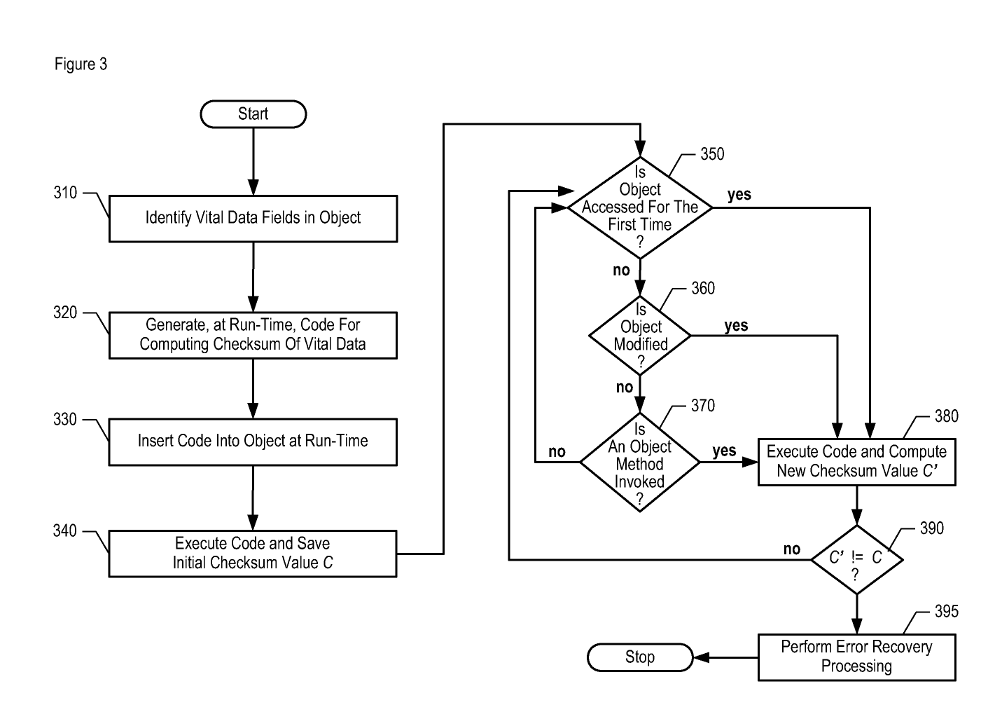

FIG. 3 depicts a method of generating and deploying code at run-time for detecting the corruption of vital object data, in accordance with the second illustrative embodiment of the present invention. It will be clear to those skilled in the art, after reading this disclosure, which tasks depicted in FIG. 3 can be performed simultaneously or in a different order than that depicted.

At task 310, the vital data fields of an object are identified, as in task 210 of the first illustrative embodiment.

At task 320, code for computing a checksum of vital data is generated at run-time, as in task 220 of the first illustrative embodiment.

At task 330, the code generated at task 320 is inserted into the object at run-time, as in task 230 of the first illustrative embodiment.

At task 340, the code generated at task 320 is executed, and the checksum value computed by the code is stored in variable C.

At task 350, if the object is accessed for the first time, then execution proceeds to task 380, otherwise execution continues at task 360.

At task 360, if the object is modified, then execution proceeds to task 380, otherwise execution continues at task 370.

At task 370, if a method of the object is invoked, then execution proceeds to task 380, otherwise execution continues back at task 350.

At task 380, the code generated at task 320 is executed, and the checksum value computed by the code is stored in variable C′.

Task 390 checks whether the values of C and C′ differ; if so, execution of the method continues at task 395, otherwise execution continues back at task 350.

At task 395, appropriate error processing is performed in response to the corruption of the vital data (e.g., lock down the system, issue an alert, etc.). After task 395, the method of FIG. 3 terminates.

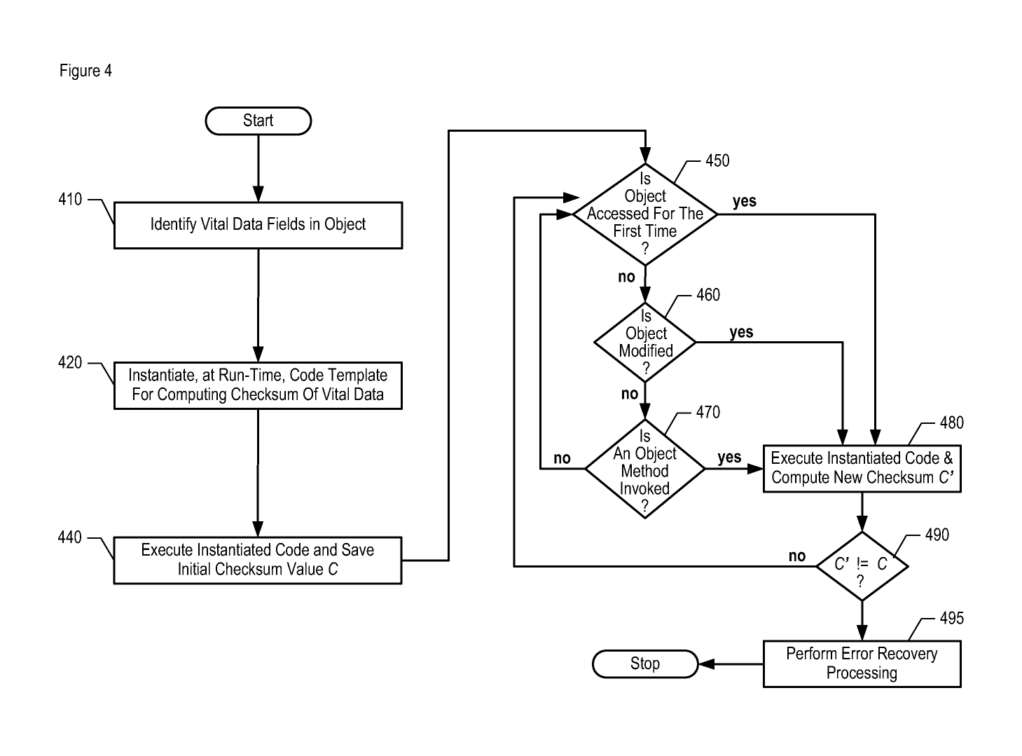

FIG. 4 depicts a method of instantiating a code template at run-time for detecting the corruption of vital object data, in accordance with the third illustrative embodiment of the present invention. It will be clear to those skilled in the art, after reading this disclosure, which tasks depicted in FIG. 3 can be performed simultaneously or in a different order than that depicted.

At task 410, the vital data fields of an object are identified, as in task 310 of the second illustrative embodiment.

At task 420, a code template for computing a checksum of vital data is instantiated (e.g., with the appropriate parameter values, etc.) at run-time, in well-known fashion.

At task 440, the code template instantiated at task 420 is executed, and the checksum value computed by the code is stored in variable C.

At task 450, if the object is accessed for the first time, then execution proceeds to task 480, otherwise execution continues at task 460.

At task 460, if the object is modified, then execution proceeds to task 480, otherwise execution continues at task 470.

At task 470, if a method of the object is invoked, then execution proceeds to task 480, otherwise execution continues back at task 450.

At task 480, the code template instantiated at task 420 is executed, and the checksum value computed by the code is stored in variable C′.

Task 490 checks whether the values of C and C′ differ; if so, execution of the method continues at task 495, otherwise execution continues back at task 450.

At task 495, appropriate error processing is performed in response to the corruption of the vital data (e.g., lock down the system, issue an alert, etc.). After task 495, the method of FIG. 4 terminates.

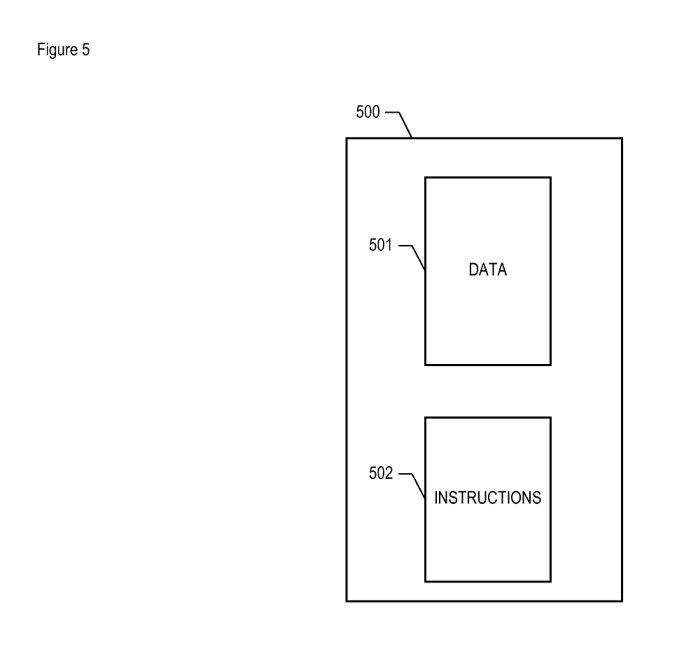

FIG. 5 depicts a schematic diagram of the memory footprint of an illustrative collection object comprising vital data, in accordance with the fourth illustrative embodiment of the present invention. As shown in FIG. 5, memory footprint 500 comprises first memory segment 501 and second memory segment 502.

First memory segment 501 stores one or more data, and is capable of storing a plurality of objects (e.g., the object corresponding to memory footprint 100 of FIG. 1, etc.), as is well known in the art. In accordance with the third illustrative embodiment, at least one, and possibly all, of the data in memory segment 501 are vital.

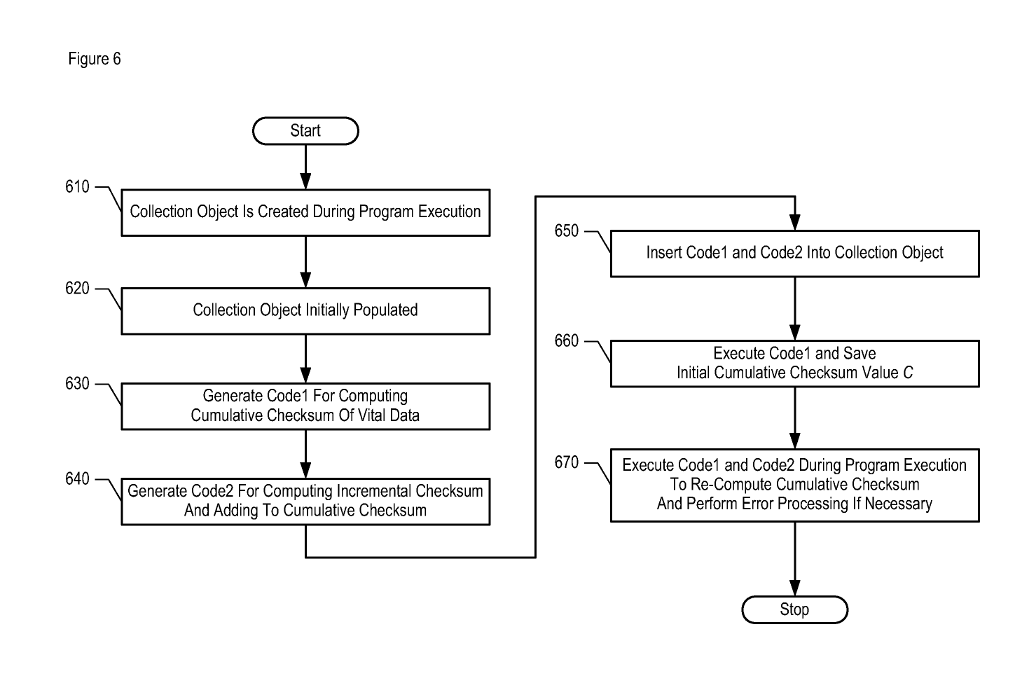

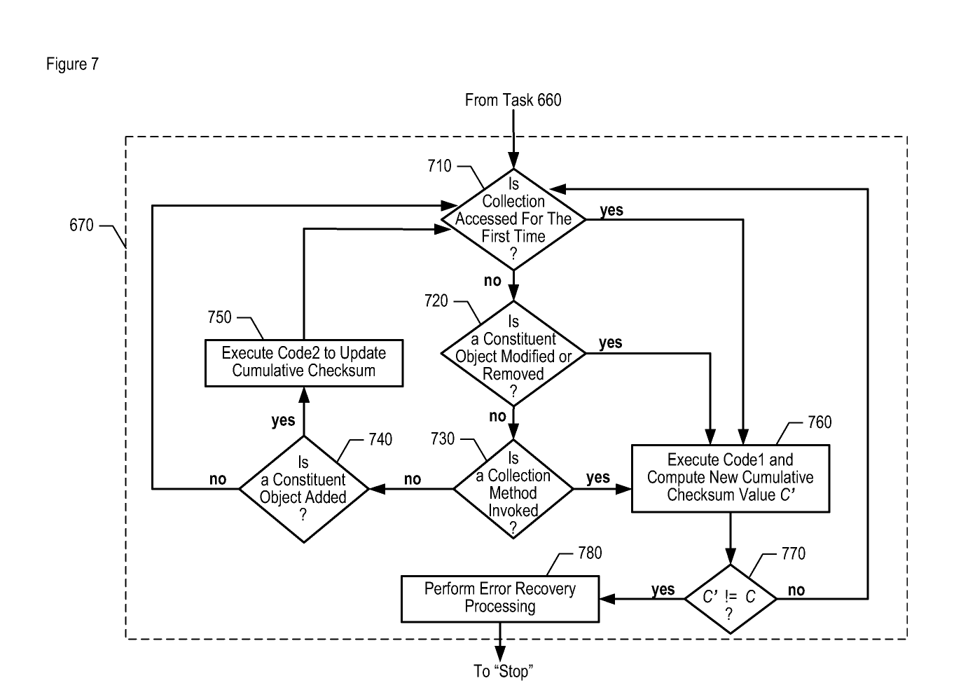

Second memory segment 502 comprises instructions corresponding to the methods of the collection object (e.g., addObject( ), removeObject( ), etc.), as is well-known in the art. In addition, a portion of memory segment 502 is reserved upon creation for subsequent insertion of instructions for computing a cumulative checksum, computing an incremental checksum, and detecting changes in vital data, as is described in detail below and with respect to FIGS. 6 and 7.

FIG. 6 depicts a method of generating and deploying code at run-time for detecting the corruption of vital data in a collection object, in accordance with the fourth illustrative embodiment of the present invention. As is well-known in the art, a collection object is a data structure such as a set, a list, a hashtable, etc. that is comprised of constituent objects. It will be clear to those skilled in the art, after reading this disclosure, which tasks depicted in FIG. 6 can be performed simultaneously or in a different order than that depicted.

At task 610, a collection object is created during the execution of an object-oriented program, in well-known fashion.

At task 620, the collection object generated at task 610 is initially populated during program execution, in well-known fashion.

At task 630, a first piece of code (“Code1”) is generated for the computation of a cumulative checksum over all vital data in the collection object. In accordance with the fourth illustrative embodiment, this first piece of code iterates over all of the constituent objects in the collection object, and for each constituent object O, dynamically invokes O's code for computing the checksum of its own vital data. The cumulative checksum is then simply the sum of the individual checksums of the constituent objects.

At task 640, a second piece of code (“Code2”) is generated for (i) computing an incremental checksum for an object O that is added to the collection object, and (ii) adding the incremental checksum to the prior cumulative checksum. As in the first piece of code, the incremental checksum is computed by invoking object O's code for computing the checksum of its own vital data.

At task 650, the code generated at tasks 630 and 640 (i.e., Code1 and Code2) are inserted into the collection object.

At task 660, Code1 is executed, and the cumulative checksum value that is computed is stored in variable C.

At task 670, Code1 and Code2 are executed during the execution of the object-oriented program to re-compute the cumulative checksum and perform error processing if necessary. Task 670 is described in detail below and with respect to FIG. 6.

After task 670, the method of FIG. 6 terminates.

FIG. 7 depicts a detailed flowchart for task 670, in accordance with the fourth illustrative embodiment of the present invention. It will be clear to those skilled in the art, after reading this disclosure, which tasks depicted in FIG. 7 can be performed simultaneously or in a different order than that depicted.

At task 710, if the collection object is accessed for the first time, then execution proceeds to task 770, otherwise execution continues at task 720.

At task 720, if a constituent object of the collection is modified or removed, then execution proceeds to task 770, otherwise execution continues at task 730.

At task 730, if a method of the collection object is invoked, then execution proceeds to task 770, otherwise execution continues at task 740.

At task 740, if a constituent object is added to the collection, then execution proceeds to task 750, otherwise execution continues back at task 710.

At task 750, Code2 is executed, which computes the checksum of the new constituent object and adds it to cumulative checksum C. After task 750, execution continues back at task 710.

At task 770, the cumulative checksum is re-computed by Code1 and stored in variable C′.

Task 770 checks whether the values of C and C′ differ; if so, execution of the method continues at task 780, otherwise execution continues back at task 710.

At task 780, appropriate error processing is performed in response to the corruption of the vital data (e.g., lock down the system, issue an alert, etc.). After task 780 is completed, the method of FIG. 6 terminates.

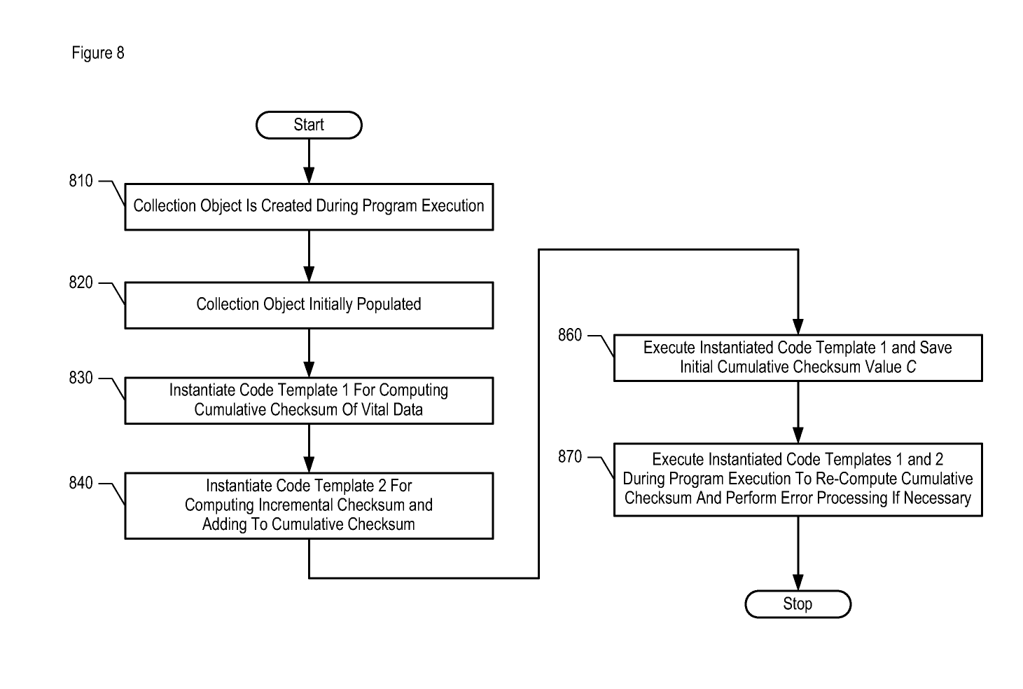

FIG. 8 depicts a method of instantiating a code template at run-time for detecting the corruption of vital data in a collection object, in accordance with the fifth illustrative embodiment of the present invention. It will be clear to those skilled in the art, after reading this disclosure, which tasks depicted in FIG. 8 can be performed simultaneously or in a different order than that depicted.

At task 810, a collection object is created during the execution of an object-oriented program, in well-known fashion.

At task 820, the collection object generated at task 810 is initially populated during program execution, in well-known fashion.

At task 830, a first code template is instantiated for the computation of a cumulative checksum over all vital data in the collection object. In accordance with the fifth illustrative embodiment, this instantiated code template iterates over all of the constituent objects in the collection object, and for each constituent object O, dynamically invokes O's code for computing the checksum of its own vital data. The cumulative checksum is then simply the sum of the individual checksums of the constituent objects.

At task 840, a second code template is instantiated for (i) computing an incremental checksum for an object O that is added to the collection object, and (ii) adding the incremental checksum to the prior cumulative checksum. As in the first code template, the incremental checksum is computed by invoking object O's code for computing the checksum of its own vital data.

At task 860, the instantiated first code template is executed, and the cumulative checksum value that is computed is stored in variable C.

At task 870, the instantiated first and second code templates are executed during the execution of the object-oriented program to re-compute the cumulative checksum and perform error processing if necessary. After task 870, the method of FIG. 8 terminates.

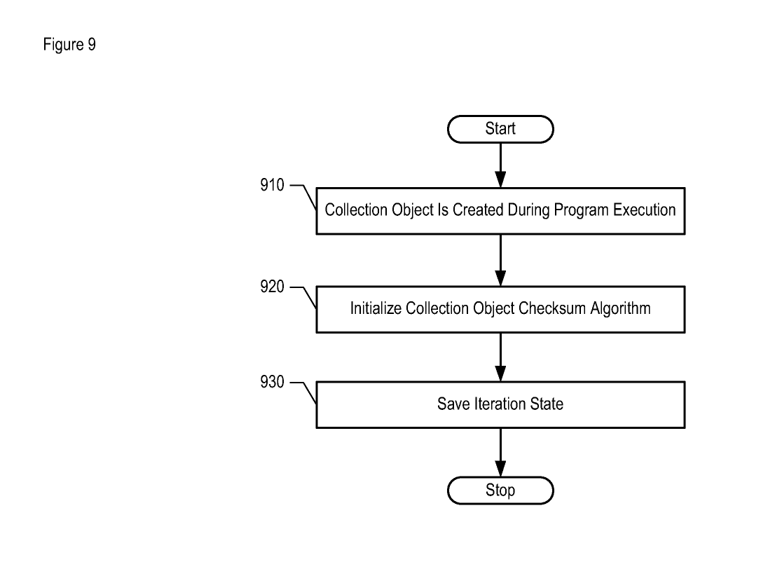

FIG. 9 depicts a method of initializing a collection object, in accordance with the sixth illustrative embodiment of the present invention.

At task 910, a collection object is created during the execution of an object-oriented program, as in task 610 of the fourth illustrative embodiment.

At task 920, the collection object's checksum algorithm is initialized.

At task 930, the iteration state is saved. After task 930, the method of FIG. 9 terminates.

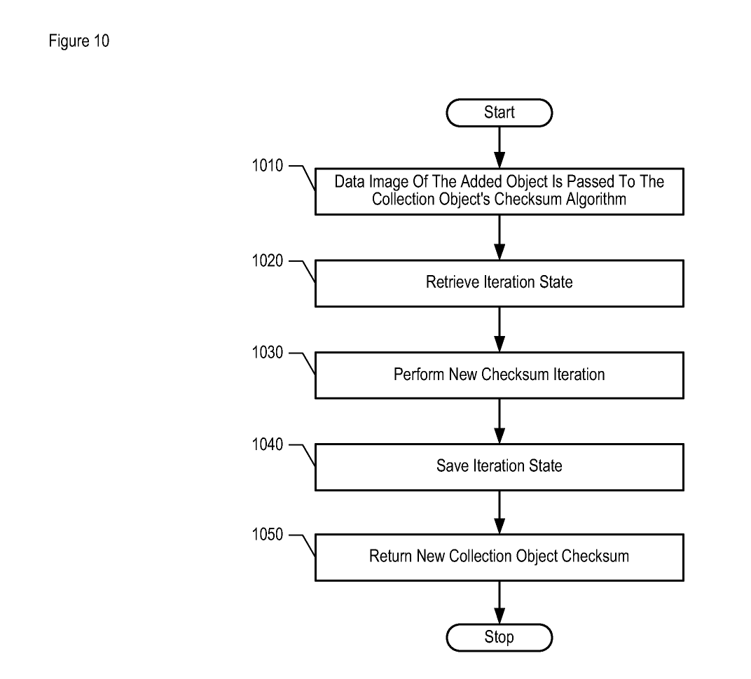

FIG. 10 depicts the salient tasks performed when an object is added to a collection object, in accordance with the sixth illustrative embodiment of the present invention.

At task 1010, the data image of the added object is passed to the collection object's checksum algorithm.

At task 1020, the iteration state is retrieved.

At task 1030, the new checksum iteration is performed.

At task 1040, the new iteration state is saved.

At task 1050, the new collection object checksum is returned. After task 1050, the method of FIG. 10 terminates.

It is to be understood that the disclosure teaches just one example of the illustrative embodiment and that many variations of the invention can easily be devised by those skilled in the art after reading this disclosure and that the scope of the present invention is to be determined by the following claims.

1. A method comprising:
generating, at run-time, a software object that comprises one or more safety-critical data;
generating, at run-time, code for detecting a change in a value of said safety-critical data; and
inserting, at run-time, said code into said software object.

2. The method of claim 1 wherein said code periodically computes a checksum of said safety-critical data.

3. The method of claim 1 wherein said code computes a checksum of said safety-critical data when said software object is created.

4. The method of claim 1 wherein the instantiated code template computes a checksum of said safety-critical data whenever said software object is modified.

5. A method comprising:
generating, at run-time, a software object that comprises:
(i) one or more safety-critical data, and
(ii) a code template for detecting a change in a value of said safety-critical data; and
instantiating said code template at run-time.

6. The method of claim 5 wherein the instantiated code template computes a checksum of said safety-critical data when said software object is first accessed.

7. The method of claim 5 wherein the instantiated code template computes a checksum of said safety-critical data whenever said software object is modified.

8. The method of claim 5 wherein said software object comprises a method M, and wherein the instantiated code template computes a checksum of said safety-critical data whenever said method M is invoked.

9. A method comprising:
generating, at run-time, a collection object that:
(i) is capable of holding one or more constituent objects, wherein at least one of said constituent objects is capable of storing a respective safety-critical datum, and
(ii) comprises a code template for computing a cumulative checksum over all of the safety-critical data of said constituent objects; and
instantiating said code template at run-time.

10. The method of claim 9 wherein the instantiated code template is executed when said collection object is initially populated.

11. The method of claim 9 wherein the instantiated code template is executed when said collection object is first accessed.

12. The method of claim 9 wherein said collection object comprises a method M, and wherein the instantiated code template is executed whenever said method M is invoked.

13. The method of claim 9 wherein the instantiated code template is executed when a constituent object is removed from said collection object.

14. The method of claim 9 wherein said collection object also comprises code for updating said cumulative checksum when a new constituent object is added to said collection object.

15. An object class comprising:
one or more safety-critical data; and
a segment of memory that is populated at run-time with code for detecting a change in a value of said safety-critical data.

16. The object class of claim 15 wherein said code periodically calculates a checksum of said safety-critical data.

17. The object class of claim 16 wherein said code is a code template that is instantiated at run-time.

18. The object class of claim 15 wherein said code computes a checksum of said safety-critical data when an instance of said object class is created.

19. The object class of claim 15 wherein said code computes a checksum of said safety-critical data when an instance of said object class is first accessed.

20. The object class of claim 15 wherein said code computes a checksum of said safety-critical data whenever an instance of said object class is modified.
